(19) United States
(12) Patent Application Publication
(10) Pub. No.: US 2020/0134680 A1
(43) Pub. Date: Apr. 30, 2020

(54) ESTIMATION METHOD, CHARGING METHOD, COMPUTER, AND PROGRAMS

(71) Applicant: FRONTEO, Inc., Tokyo (JP)

(72) Inventors: Ryota TAMURA, Tokyo (JP); Kazumi HASUKO, Tokyo (JP); Shinya IGUCHI, Tokyo (JP)

(21) Appl. No.: 16/590,505

(22) Filed: Oct. 2, 2019

(30) Foreign Application Priority Data
Oct. 29, 2018 (JP) 2018-203078

(51) Int. Cl. G06Q 30/02; G06N 5/04; G06N 20/00

(52) U.S. Cl. CPC G06Q 30/0283; G06N 20/00; G06N 5/04

(57) ABSTRACT

To acquire an estimated price that is more accurate and capable of acquiring a sense of consent from a client more readily than the estimated price acquired by a conventional estimation method. A computer includes a memory and a controller. The memory stores data set, and the controller executes: prediction processing for predicting time required for review work of each piece of electronic data based on a feature amount of content included in the electronic data; evaluation processing for evaluating the number of steps required for the review work of the data set based on the time predicted in the prediction processing for each piece of electronic data; and estimation processing for estimating the cost required for the review work of the data set based on the number of steps evaluated in the evaluation processing.

### BACKGROUND OF THE INVENTION

### Field of the Invention

The present disclosure relates to an estimation method for estimating the cost required for review work of data sets. Further, the present disclosure relates to a charging method including estimation processing for estimating the cost required for the review work of the data sets according to such estimation method, a computer executing such estimation method, a program for executing such estimation method, and a program for executing such charging method.

### Description of the Related Art

A contractor undertaking work for reviewing (referred to as “review work” hereinafter) a data set including at least one piece of electronic data needs to present the cost required for the review work to a client who orders the review work before completing the review work. Therefore, before completing the review work, the contractor needs to estimate the cost required for the review work according to the number of steps required for the review work (referred to as “the number of review steps” hereinafter). However, the time required for reviewing each piece of electronic data (referred to as “reviewing time” hereinafter) included in the data set fluctuates depending on the characteristic of contents included in the electronic data. Therefore, when the review cost is estimated based on a simple assumption that the number of review steps is proportional to the number of pieces of electronic data included in the data set, the estimated price becomes extremely inaccurate.

Thus, the contractor conventionally evaluates the number of review steps (unknown) of the data set to be a subject of estimation (referred to as “subject data set” hereinafter) based on the number of review steps (already known) of a data set that is similar to the subject data set and whose review work is already completed (referred to as “reference data set” hereinafter), and estimates the review cost of the subject data set based on the evaluated number of review steps. For example, the contractor considers the number of review steps of the reference data set as the number of review steps of the subject data set, and multiplies a prescribed unit cost (cost per unit number of steps) to the number of review steps to estimate the review cost of the subject data set (see International Publication No. WO 2017/068750).

However, with the conventional estimation method, estimation of the review cost becomes inappropriate (too low or too high for the actual number of review steps) because the evaluation of the number of review steps is inaccurate.

A more specific example of such problem will be described as follows.

First, the reference data set referred when evaluating the number of review steps of the subject data set is selected by the contractor (for example, person in charge of sales). When selecting the reference data set, the contractor can refer to various kinds of information such as: (1) kinds of review work (kinds of law suits in a case of review work for discovery, for example); (2) the number of pieces of data for each kind of data (for each extension, for example) included in the subject data set; and (3) languages of data included in the subject data set, for example.

However, there are normally electronic data with different characteristics (for example, size, complication, emotionality, and the like) of contents existing in the subject data set and the reference data set. This means that there are electronic data of different reviewing time existing therein, because the reviewing time of the electronic data depends on the characteristics of the content. Regarding the subject data set in particular, the contractor cannot know what proportion of the electronic data requiring the reviewing time of what extent is included therein before completing the review work. Therefore, there may be such circumstance that the proportions vary even between the subject data set and the reference data set the contractor determines to be similar. For example, there may be a circumstance where the reference data set includes 15% of data whose reviewing time is 5 minutes or more, 60% of data whose reviewing time is 1 minute or more and less than 5 minutes, and 25% of data whose reviewing time is less than 1 minute, while the subject data set includes 50% of data whose reviewing time is 5 minutes or more, 40% of data whose reviewing time is 1 minute or more and less than 5 minutes, and 10% of data whose reviewing time is less than 1 minute.

Therefore, even when the contractor selects the reference data set similar to the subject data set by referring to each kind of information described above, evaluation of the number of review steps of the subject data set based on the number of review steps of the reference data set becomes inaccurate. As a result, the review cost estimated based on the evaluated number of steps becomes inappropriate.

With the conventional estimation method, the possibility of overestimating the review cost by the contractor cannot be eliminated so that, in some cases, there may generate secondary problem that the client feels a low sense of consent for the estimation of the review cost.

That is, with the conventional estimation method, the review cost is calculated based on the number of review steps of the subject data set evaluated by the contractor. Therefore, it is not possible to eliminate the possibility of overestimating the review cost when the contractor intentionally overevaluates the number of review steps of the subject data set. This gives a sense of distrust to the client, and becomes a cause for making it harder for the client to have a sense of consent for the estimated price. Other than acquiring excessive profits, another purpose for the contractor to overestimate the review cost may be to avoid a pressure on the profits and delay in the work which may be caused when the capability of the reviewer is low (when the review speed is slow).

From another point of view, this problem can also be described as follows. That is, overevaluating the number of review steps leads to the profits of the contractor because the estimated price becomes higher. In the meantime, underevaluating the number of review steps leads to the profits of the client because the estimated price becomes lower. Because the profits of the contractor and the profits of the client conflict with each other as described above, it is difficult to acquire the estimated price satisfied by the client with the conventional estimation method where voluntariness of the contractor may be included in the evaluation of the number of review steps.

An aspect of the present disclosure is designed in view of the above-described problem, and an object thereof is to perform estimation of the review cost more appropriately than conventional cases.

### SUMMARY OF THE INVENTION

In order to overcome the above-described problem, the estimation method according to an aspect of the present disclosure is an estimation method for estimating a cost required for review work of a data set including at least one piece of electronic data by using a computer including a memory and a controller, the estimation method including: storing processing for storing the data set to the memory; prediction processing executed by the controller to predict time required for the review work of each piece of electronic data based on a feature amount of a content included in the electronic data; evaluation processing executed by the controller to evaluate the number of steps required for the review work of the data set based on the time predicted in the prediction processing for each piece of the electronic data; and estimation processing executed by the controller to estimate the cost required for the review work of the data set based on the number of steps evaluated in the evaluation processing.

Further, in order to overcome the above-described problem, the computer according to an aspect of the present disclosure is a computer including a memory and a controller for estimating a cost required for review work of a data set including at least one piece of electronic data, wherein: the memory stores the data set; and the controller executes prediction processing for predicting time required for the review work of each piece of electronic data based on a feature amount of a content included in the electronic data, evaluation processing for evaluating the number of steps required for the review work of the data set based on the time predicted in the prediction processing for each piece of the electronic data, and estimation processing for estimating the cost required for the review work of the data set based on the number of steps evaluated in the evaluation processing.

According to one of the aspects of the present disclosure, it is possible to perform estimation of the review cost more appropriately than conventional cases.

### BRIEF DESCRIPTION OF THE DRAWINGS

FIG. 1 is a block diagram illustrating a configuration of a computer according to a first embodiment of the present disclosure;

FIG. 2 is a flowchart illustrating a flow of an estimation method of a review cost performed by using the computer illustrated in FIG. 1;

FIG. 3 is a flowchart illustrating a flow of a construction method of a prediction model, which can be performed as a part of the estimation method illustrated in FIG. 2;

FIG. 4A is a flowchart illustrating a first specific example of setting processing included in the construction method illustrated in FIG. 3;

FIG. 4B is a table of correlations;

FIG. 5A is a flowchart illustrating a second specific example of setting processing included in the construction method illustrated in FIG. 3;

FIG. 5B is an example of a regression equation;

FIG. 6A is a flowchart illustrating a third specific example of setting processing included in the construction method illustrated in FIG. 3; and

FIG. 6B is an example of a regression tree.

### DETAILED DESCRIPTION OF THE PREFERRED EMBODIMENTS

### [Configuration of Computer]

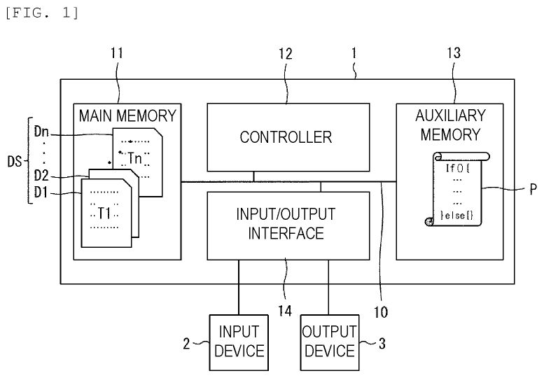

The configuration of a computer 1 according to an embodiment of the present disclosure will be described by referring to FIG. 1. FIG. 1 is a block diagram illustrating the configuration of the computer 1.

As illustrated in FIG. 1, the computer 1 includes a bus 10, a main memory 11, a controller 12, an auxiliary memory 13, and an input/output interface 14. The controller 12, the auxiliary memory 13, and the input/output interface 14 are connected mutually via the bus 10. As the main memory 11, a single or a plurality of semiconductor RAM (Random Access Memory) is used, for example. As the controller 12, a single or a plurality of CPU (Central Processing Unit) is used, for example. As the auxiliary memory 13, an HDD (Hard Disk Drive) is used, for example. As the input/output interface 14, a USB (Universal Serial Bus) interface is used, for example.

To the input/output interface 14, an input device 2 and an output device 3 are connected, for example. As the input device 2, a keyboard and a mouse are used, for example. As the output device 3, a display and a printer are used, for example. Like a laptop computer, the computer 1 may have a keyboard functioning as the input device 2 and a display functioning as the output device 3 built therein. Further, like a smartphone or a tablet computer, the computer 1 may have a touch panel functioning as the input device 2 and the output device 3 built therein.

In the auxiliary memory 13, stored is a program P for causing the computer 1 to perform an estimation method S1 to be described later. The controller 12 expands the program P stored in the auxiliary memory 13 on the main memory 11 and executes each instruction included in the program P expanded on the main memory 11 to execute each step included in the estimation method S1 to be described later. In the auxiliary memory 13, also stored is a data set DS the computer 1 refers to in the estimation method S1 to be described later. The data set DS is a set of at least a single piece of electronic data D1, D2, . . . , Dn (n is any natural number of 1 or larger). The controller 12 expands each piece of electronic data Di (i=1, 2, . . . , n) stored in the auxiliary memory 13 on the main memory 11, and refers thereto in each of the steps included in the estimation method S1 to be described later.

While there is described a mode where the computer 1 performs the estimation method S1 to be described later by using the program P stored in the auxiliary memory 13 as an internal storage medium, the present disclosure is not limited to that. That is, it is also possible to employ a mode where the computer 1 performs the estimation method S1 to be described later by using the program P stored in an external recording medium. In such case, as the external recording medium, it is possible to use “non-transitory tangible medium” capable of being read by the computer 1, such as a tape, a disk, a card, a semiconductor memory, a programmable logic circuit, or the like. Alternatively, it is also possible to employ a mode where the computer 1 performs the estimation method S1 to be described later by using the program P acquired via a communication network. In such case, as the communication network, it is possible to use the Internet, LAN, or the like, for example.

### [Estimation Method of Reviewing Time]

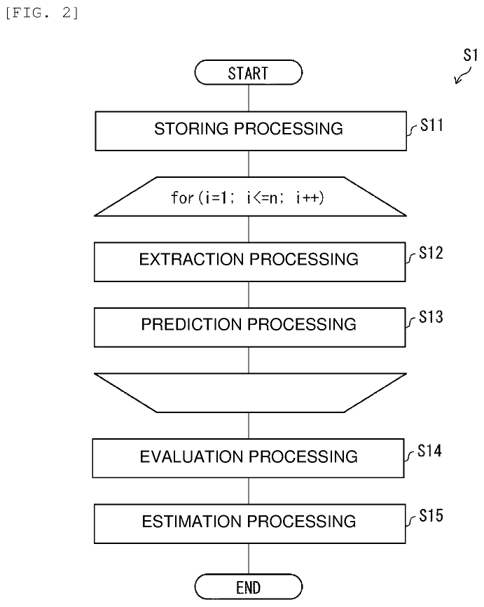

The estimation method S1 of the reviewing time according to an embodiment of the present disclosure will be described by referring to FIG. 2. FIG. 2 is a flowchart illustrating a flow of the estimation method S1 of the reviewing time.

The estimation method S1 is a method for estimating the review cost of the data set DS by using the computer 1. As illustrated in FIG. 2, the estimation method S1 includes storing processing S11, extraction processing S12, prediction processing S13, evaluation processing S14, and estimation processing S15.

The storing processing S11 is processing for storing the data set DS in the memory (the main memory 11 or the auxiliary memory 13) of the computer 1. The storing processing S11 is executed under control of the controller 12 of the computer 1.

The data set DS is a set of electronic data D1, D2, . . . , Dn. Each piece of electronic data Di includes text Ti as a content. An example of such electronic data may be TXT data (plaintext data), RTF data (rich text data), HTML data, XML data, PDF data, DOC data, or EML data.

The extraction processing S12 is processing for extracting an attribute value (for example, 100 characters) of a preselected attribute (for example, the number of characters) of the text Ti included in the electronic data Di included in the data set DS from the electronic data Di stored in the memory, regarding each piece of electronic data Di included in the data set DS. The extraction processing S12 is executed by the controller 12 of the computer 1 after executing the storing processing S11.

Hereinafter, the attribute value extracted in the extraction processing S12 is referred to as a feature amount, and a set of the attribute values extracted in the extraction processing S12 is referred to as a feature amount group GC. The feature amount group GC may include: (1) a first feature amount C1 indicating complexity of the text T; (2) a second feature amount C2 indicating size of the text T; and (3) a third feature amount C3 indicating emotionality of the text T.

Examples of the attribute values of the text T capable of being used as the first feature amount C1 may be the number of types of words, the number of word classes, TTR (Type Token Ratio), CTTR (Corrected Type Token Ratio), Yule's K, the number of dependencies, and numerical value ratios. It is also possible to use a combination of some or all those attribute values indicating the complexity of the text T as the first feature amount C1. Note that definitions of those attribute values will be described later.

Examples of the attribute values of the text T capable of being used as the second feature amount C2 may be the number of characters, the number of words, the number of sentences, and the number of paragraphs. It is also possible to use a combination of some or all those attribute values indicating the size of the text T as the second feature amount C2. Note that definitions of those attribute values will be described later.

Examples of the attribute values of the text T capable of being used as the third feature amount C3 may be the positive number and the negative number. Note here that the positive number indicates positiveness of the text T, and is defined by the number of appearance time of a word predefined as a positive word in the text T, for example. Further, the negative number indicates negativeness of the text T, and is defined by the number of appearance time of a word predefined as a negative word in the text T, for example.

Note that the number of appearance times of each part of speech in the text T may be included in the feature amount group GC. For example, each word included in the text T may be classified into English character, unknown word, noun, verb, adjective, adverb, interjection, prefix, auxiliary verb, conjunction, filler, pronoun adjectival, postpositional word, sign, numeral, and others, and the number of appearance times of each of those parts of the speech in the text T may be included in the feature amount group GC.

The prediction processing S13 is processing for predicting reviewing time ti of the electronic data Di based on the feature amount group GC extracted in the extraction processing S12, regarding each piece of electronic data Di included in the data set DS. The prediction processing S13 is executed by the controller 12 of the computer 1 after executing the extraction processing S12. Note here that the reviewing time means the time required for a human to review the outputted (displayed, printed, or read out) text T.

For executing the prediction processing S13, the controller 12 calculates the reviewing time ti of the electronic data Di from the feature amount group GC extracted by the extraction processing S12 according to a prediction model constructed in advance, for example. The prediction model used in the prediction processing S13 is a prediction model constructed by machine learning having the feature amount group GC of the text Ti included in the electronic data Di as input and having the reviewing time ti as output, and examples thereof may be ELM (Extreme Learning Machine), SVR (Support Vector Machine), regression tree, XGBoost, random forest, and DNN (Deep Neural Network). Note that a construction method S2 of the prediction model used in the prediction processing S13 will be described later by changing the drawing to be referred to.

The evaluation processing S14 is processing for evaluating the number of review steps mh of the data set DS based on the reviewing time ti predicted in the prediction processing S13 regarding each piece of electronic data Di. The evaluation processing S14 is executed by the controller 12 of the computer 1 after completing the prediction processing S13 on all of the electronic data D1, D2, . . . , Dn included in the data set DS.

For executing the evaluation processing S14, the controller 12 calculates the sum total “t=t1+t2+ . . . +tn” of the reviewing time t1, t2, . . . , tn predicted in the prediction processing S13, for example, and calculates the number of review steps “mh=α×t” that is proportional to the calculated sum total t. Note here that “α” is a constant of proportionality. For example, a unit of each reviewing time ti is “hour” and when the work time of each reviewer per day is 8 hours, it is possible to calculate the number of review steps mh of “man-day” provided that “α” is ⅛.

The estimation processing S15 is processing for estimating review cost c of the data set DS based on the number of review steps mh evaluated in the evaluation processing S14. The estimation processing S15 is executed by the controller 12 of the computer 1 after executing the evaluation processing S14. Note here that the review cost is compensation paid for the work done by a human for reviewing the electronic data D1, D2, . . . , Dn included in the data set DS. The review cost c calculated in the estimation processing S15 is written in an estimation sheet or a bill issued by the contractor undertaking the review work for the client ordering the review work, for example.

For executing the estimation processing S15, the controller 12 calculates the review cost “c=β×mh” that is proportional to the number of review steps mh evaluated in the evaluation processing S14, for example. Note here that “β” is a constant of proportionality, and indicates the review cost per unit number of steps.

As described above, with the estimation method S1 according to the embodiment, the reviewing time ti of each piece of electronic data Di included in the data set DS is predicted based on the feature amount of the text Ti included in the electronic data Di, and the number of review steps mh of the data set DS is evaluated based on the reviewing time t1, t2, . . . , tn of the electronic data D1, D2, . . . , Dn included in the data set DS. That is, evaluation of the number of review steps mh of the data set DS performed based on the number of review steps of the reference data set in the conventional estimation method is performed based on the feature amount of the texts T1, T2, . . . , Tn included in the electronic data D1, D2, . . . , Dn with the estimation method S1 according to the embodiment. Therefore, with the estimation method S1 according to the embodiment, it is possible to: (a) perform evaluation of the number of review steps mh more accurately than conventional cases; and (b) decrease possibility for the contractor to intentionally overevaluate the number of review steps mh than conventional cases. Therefore, with the estimation method S1 according to the embodiment, it is possible to: (a) perform estimation of the review cost c more appropriately than conventional cases; and (b) increase a sense of consent felt by the client for the estimation of the review cost c than conventional cases.

Note that the controller 12 may execute switching processing for switching the feature amounts to be included in the feature amount group GC according to the kind of the electronic data Di prior to the extraction processing S12. The kind of the electronic data Di can be determined based on the extension included in the file name of the electronic data Di, for example. In such case, it is possible to perform evaluation of the number of steps more appropriately according to the kind of the electronic data Di. In such case, the construction method S2 to be described hereinafter is performed for each kind of the electronic data Di, and the prediction model to be used in the prediction processing S13 is constructed for each kind of the electronic data Di.

### [Definitions of Each Feature Amount]

Among the attribute values of the text T, there are the number of types of words, the number of word classes, TTR, CTTR, Yule's K, the number of dependencies, numerical value ratios, and the like as the attribute values capable of being used as the first feature amount C1. Those attribute values can be defined as follows, for example.

The number of types of words (the number of lexes) of the text T can be defined as the number of different words appearing in the text T, for example. For example, when the text T is “sumomo mo momo mo momo no uchi (meaning “both plums and peaches are a kind of peach” in English), the text T can be morphologically analyzed to “sumomo (plums)/mo (and)/momo (peaches)/mo (both)/momo (peach)/no (of)/uchi (a kind)”. The different words appearing in the text T are five words that are “sumomo”, “mo”, “momo”, “no”, and “uchi”, so that the number of types of words of the text T is 5. It is to be noted herein that the word “momo” appearing twice is not counted separately (this is the same for the morpheme “mo” appearing twice).

The number of word classes of the text T can be defined as the number of word classes appearing in the text T. For example, when the text T is “sumomo mo momo mo momo no uchi”, the text T can be morphologically analyzed to “sumomo (noun)/mo (postpositional word)/momo (noun)/mo (postpositional word)/momo (noun)/no (postpositional word)/uchi (noun)”. Therefore, there are two parts of speech appearing in the text T, namely noun and postpositional word, so that the number of word classes of the text T is 2.

TTR of the text T can be defined by following expression (1) where the number of words (token) in the text T is N and the number of types of words of the text T is V, for example. For example, when the text T is “sumomo mo momo mo momo no uchi”, the text T can be morphologically analyzed to “sumomo/mo/momo/mo/momo/no/uchi”. The token is 7 and the number of types of words is 5, so that TTR of the text T is “ 5/7=0.714.”

$$\begin{matrix}[ Expression 1 ] & \\ TTR = \frac{V}{N} & ( 1 )\end{matrix}$$

CTTR of the text T can be defined by following expression (2) where the token in the text T is N and the number of types of words of the text T is V, for example. For example, when the text T is “sumomo mo momo mo momo no uchi”, the text T can be morphologically analyzed to “sumomo/mo/momo/mo/momo/no/uchi”. The token is 7 and the number of types of words is 5, so that CTTR of the text T is “5/(2×7)^{1/2}≈1.34.”

$$\begin{matrix}[ Expression 2 ] & \\ CTTR = \frac{V}{\sqrt{2 N}} & ( 2 )\end{matrix}$$

The Yule's K of the text T can be defined by following expression (3) where the token in the text T is N, the type appearing in the text T m-times is V(m), for example. For example, when the text T is “sumomo mo momo mo momo no uchi”, the text T can be morphologically analyzed to “sumomo/mo/momo/mo/momo/no/uchi”. The token is 7, the words appearing once in the text T are three words that are “sumomo”, “no”, and “uchi”, and the words appearing twice in the text T are two words that are “momo” and “mo”, so that the Yule's K of the text T is “10⁴×(3×1²+2×2²−7)/7²≈816.”

$$\begin{matrix}[ Expression 3 ] & \\ K = {10}^{4} \frac{{\sum }_{m} V ( m ) {m}^{2} - N}{{N}^{2}} & ( 3 )\end{matrix}$$

The number of dependencies in the text T can be defined as the total of the number of edges (arcs) in a semantic dependency graph of each sentence included in the text T, for example. For example, when the text T is “watashi wa raamen wo tabe ni Tokyo e iku (meaning “I go to Tokyo to eat ramen” in English). Tokyo no raamen wa oishii (meaning “ramen in Tokyo is delicious” in English).”, there are four edges in the semantic dependency graph of the first sentence, which are “watashi wa (I)→iku (go)”, “Tokyo ni (to Tokyo)→iku (go)”, “raamen wo (ramen)→tabe ni (to eat)”, and “tabe ni (to eat)→iku (go)”, and there are two edges in the semantic dependency graph of the second sentence, which are “Tokyo no (in Tokyo)→raamen (ramen)” and “raamen wa (ramen)→oishii (is delicious)”. Therefore, the number of dependencies in the text T is 6.

The numerical value ratios of the text T can be defined as the value of the ratio of the number of numerals in the text T (the number of numerals included in the text T) with respect to the number of characters of the text T, or as the value of the ratio of the number of numerical values in the text T (the number of numerical values included in the text T; consecutive numerals are counted as one numerical value) with respect to the number of words in the text T. For example, when the text T is “raamen wa 650 en desu (meaning “ramen costs 650 yen)”, the numerical value ratio of the text T is 3/11≈0.272 (in the case of the former definition where “ra/a/me/n/wa/6/5/0/en/de/su”) or 1/5≈0.2 (in the case of the latter definition where “ramen/wa/650/en/desu”).

Among the attributes of the text T, there are the number of characters, the number of words, the number of sentences, the number of paragraphs, and the like as the attributes capable of being used as the second feature amount C2. Definitions of those attributes can be defined as follows, for example.

The number of characters in the Text T can be defined as the number of characters included in the text T, for example. For example, when the text T is “sumomo mo momo mo momo no uchi”, the number of characters in the text T in Japanese is 12 (“su” “mo” “mo” “mo” “mo” “mo” “mo” “mo” “mo” “no” “u” “chi”). It is to be noted herein that the character “mo” appearing six times is counted separately.

The token of the text T can be defined as the number of words (morphemes) included in the text T, for example. For example, when the text T is “sumomo mo momo mo momo no uchi”, the text T can be morphologically analyzed to “sumomo/mo/momo/mo/momo/no/uchi”. Therefore, the token in the text T is 7. It is to be noted herein that the word “momo” appearing twice is counted separately (this is the same for the word “mo” appearing twice).

The number of sentences of the text T can be defined as the number of sentences included in the text T, for example. The number of sentences in the text T can be specified by counting the number of separators (for example, periods) included in the text T, for example.

The number of paragraphs of the text T can be defined as the number of paragraphs included in the text T, for example. The number of paragraphs in the text T can be specified by counting the number of separators (for example, line feed codes) of the paragraphs included in the text T, for example.

The above-described definitions of each of the attribute values (feature amounts) of the text T are merely specific examples for providing an example of an embodiment of the estimation method S1, and can be changed as appropriate. That is, each of the attribute values of the text T can be stipulated by definitions different from the definitions described above, as long as the definitions do not contradict these general principles. For example, TTR of the text T quantitatively expresses the concept of “lexical richness”, and may be stipulated by the above-described definition (TTR=V/N) or may be stipulated by a definition (for example, TTR=Log(V)/Log(N)) that is different from the above-described definition.

### [Construction Method of Prediction Model]

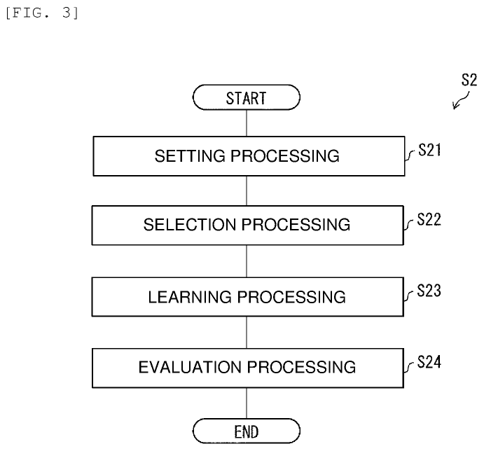

The construction method S2 of the prediction model will be described by referring to FIG. 3. FIG. 3 is a flowchart illustrating a flow of the construction method S2 of the prediction model.

The construction method S2 is a method for constructing the prediction model used in the above-described prediction processing S13 by using the computer 1, and is performed prior to the above-described extraction processing S12 as a part of the estimation method S1 described above. As illustrated in FIG. 3, the construction method S2 includes setting processing S21, selection processing S22, learning processing S23, and evaluation processing S24.

The setting processing S21 is processing for setting the importance of each of the attributes included in a predefined attribute group GA by referring to some or all a sample data group. In the setting processing S21, the importance of the attribute exhibiting a large influence on the reviewing time is set as high while the importance of the attribute exhibiting a small influence on the reviewing time is set as low. The setting processing S21 is executed by the controller 12 of the computer 1.

Note here that the sample data group means a set of sample data including the text whose reviewing time is actually measured in advance. The sample data group is stored in the auxiliary memory 13 built in the computer 1 or an external storage (not illustrated in FIG. 1) connected to the computer 1, for example. Further, the attribute group GA is a set of attributes of the text defined in advance. Examples of the attributes of the text that can be elements of the attribute group GA are the number of types of words, the number of word classes, TTR, CTTR, Yule's K, the number of dependencies, numerical value ratios (heretofore, the attributes whose attribute values can be the first feature amount C1), the number of characters, the number of words, the number of sentences, the number of paragraphs (heretofore, the attributes whose attribute values can be the second feature amount C2), and the positive number, negative number (heretofore, the attributes whose attribute values can be the third feature amount C3). A specific example of the setting processing S21 will be described later by changing the drawing to be referred to.

The selection processing S22 is processing for selecting the attributes whose attribute values are to be included in the feature amount group GC from the attribute group GA. In the selection processing S22, the attribute with the higher importance set by the setting processing S21 is selected more preferentially. For example, the predefined number of attributes are selected in a descending order of the importance set by the setting processing S21. The selection processing S22 is executed by the controller 12 of the computer 1 after executing the setting processing S21.

The learning processing S23 is processing for allowing machine learning of the prediction model having the attributes selected by the selection processing S22 by referring to some or all sample data included in the sample data group as input (explanatory variable) and having the reviewing time as output (objective variable), so that the prediction accuracy is improved. The learning processing S23 is executed by the controller 12 of the computer 1 after executing the selection processing S22. The learning processing S23 may be performed by referring to all the sample data that can be referred to or may be performed by referring to a part of the sample data that can be referred to. Further, the learning processing S23 may be performed by referring to the same sample data that is referred to in the setting processing S21 or may be performed by referring to the sample data different from the sample data referred to in the setting processing S21.

Note that tuning processing may be executed before executing the learning processing S23 in order to make the learning processing S23 efficient. Note here that the tuning processing means processing for tuning hyper parameters of the prediction model. Examples of a parameter tuning (parameter search) method may be grid search, random search, Bayesian optimization, and meta-heuristic search, and which method is to be used may be determined by performing a benchmark test and by taking the learning speed of the model into consideration.

Further, in order to acquire the prediction model of predefined accuracy, evaluation processing may be executed after executing the learning processing S23. Note here that the evaluation processing means processing for evaluating the prediction accuracy of the prediction model (for example, a difference between the reviewing time predicted by the prediction model and the actually measured reviewing time) by using the sample data not used in the learning processing S23 among the sample data included in the sample data group. Further, well-known K-Fold Cross Validation method may also be used in order to efficiently perform the learning processing S23 and the evaluation processing.

With the construction method S2, it is possible to construct the prediction model having the attribute that exhibits a large influence on the reviewing time and is selected by the selection processing S22 as input. Therefore, it is possible to construct the prediction model of lower calculation cost compared to the prediction model having all the attributes as input and of higher prediction accuracy compared to the prediction model having randomly selected attributes as input.

### [First Specific Example of Setting Processing]

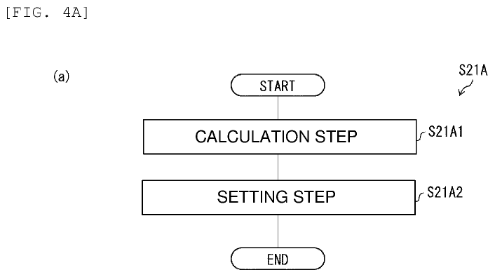

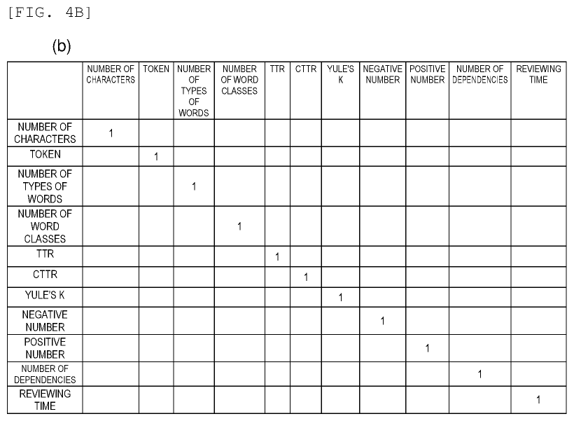

A first specific example (hereinafter, referred to as “setting processing S21A”) of the setting processing S21 will be described by referring to FIG. 4. FIG. 4A is a flowchart illustrating a flow of the setting processing S21A.

As illustrated in FIG. 4A, the setting processing 21A includes calculation step S21A1 and setting step S21A2.

Calculation step S21A1 is a step that calculates correlation coefficients between each of the attributes included in the attribute group GA and the actually measured reviewing time by referring to some or all the sample data group. Calculation step S21A1 is executed by the controller 12 of the computer 1.

Setting step S21A2 is a step that sets the importance of each of the attributes included in the attribute group GA to values according to the correlation coefficients that are calculated by calculation step S21A1 and correspond to the attributes. Note that setting step S21A2 is executed by the controller 12 of the computer 1 after executing calculation step S21A1.

Note that the importance of each of the attributes set in setting step S21A2 may be the correlation coefficient itself corresponding to the respective attribute or may be another numerical value calculated from the correlation coefficient corresponding to the respective attribute, for example. Note, however, that the importance of each of the attributes set in setting step S21A2 is preferable to become higher as the correlation coefficient corresponding to the respective attribute becomes larger and to become lower as the correlation coefficient corresponding to the respective attribute becomes smaller.

Further, the importance of each of the attributes set in setting step S21A2 may be set by considering not only the correlation coefficient between the attributes and the reviewing time but also correlation coefficients between the attribute and other attributes. In such case, a correlation matrix as illustrated in FIG. 4B is crated. Then, when the correlation coefficient between two attributes is larger than a predefined threshold value, the importance of one of the attributes is set low so that the attribute is not selected in the selection processing S22. This makes it possible to decrease multicollinearity of the prediction model.

### [Second Specific Example of Setting Processing]

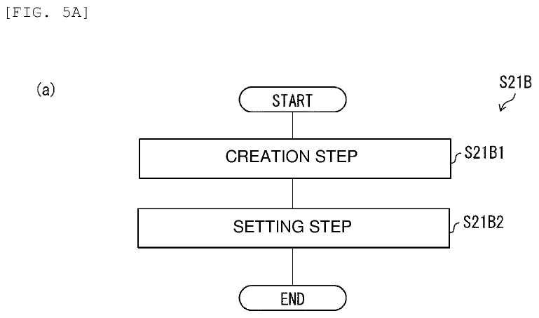

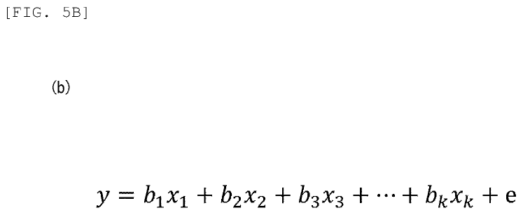

A second specific example (hereinafter, referred to as “setting processing S21B”) of the setting processing S21 will be described by referring to FIG. 5. FIG. 5A is a flowchart illustrating a flow of the setting processing S21B.

As illustrated in FIG. 5A, the setting processing S21B includes creation step S21B1 and setting step S21B2.

Creation step S21B1 is a step that creates a multiple regression equation having each of the attributes included in the attribute group GA as the explanatory variable and the reviewing time as the objective variable by referring to the sample data group. FIG. 5B shows an example of the multiple regression equation created by creation step S21B1. The multiple regression equation shown in FIG. 5B is a multiple regression equation having attributes x₁, x₂, . . . , xₖ included in the attribute group GA as the explanatory variables and the reviewing time y as the objective variable. In the multiple regression equation shown in FIG. 5B, b₁, b₂, . . . , bₖ are partial regression variables, and “e” is an error. Creation step S21B1 is executed by the controller 12 of the computer 1.

Setting step S21B2 is a step that sets the importance of each of the attributes included in the attribute group GA to the values according to the extent of the partial regression coefficient corresponding to the attribute in the multiple regression equation created by creation step S21B1. Setting step S21B2 is executed by the controller 12 of the computer 1 after executing creation step S21B1.

Note that the importance of each of the attributes set in setting step S21B2 may be the extent of the partial regression coefficient itself corresponding to the respective attribute or may be another numerical value calculated from the extent of the partial regression coefficient corresponding to the respective attribute, for example. Note, however, that the importance of each of the attributes set in setting step S21B2 is preferable to become higher as the extent of the partial regression coefficient corresponding to the respective attribute becomes larger and to become lower as the extent of the partial regression coefficient corresponding to the respective attribute becomes smaller.

According to the present specific example, the multiple regression equation acquired by excluding the term corresponding to the attribute selected in the selection processing S22 from the multiple regression equation created in creation step S21B1 can be utilized as the prediction model that is used in the prediction processing S13. Thereby, when performing the construction method S2, the learning processing S23 can be omitted. Therefore, it is possible to suppress the calculation cost required for performing the construction method S2.

### [Third Specific Example of Setting Processing]

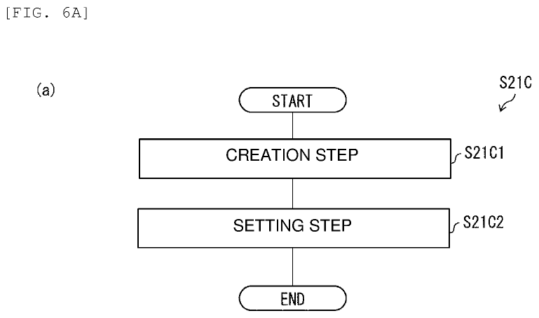

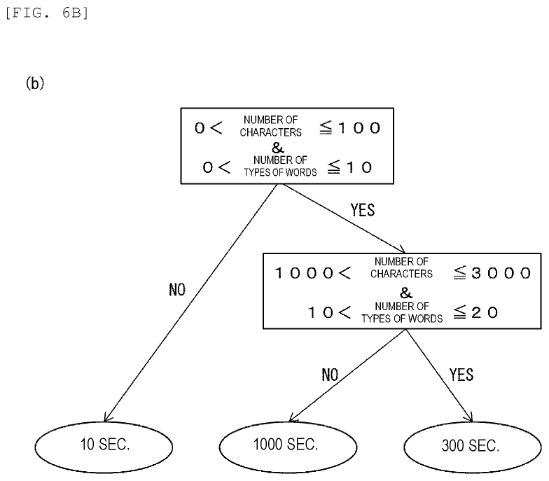

A third specific example (hereinafter, referred to as “setting processing S21C”) of the setting processing S21 will be described by referring to FIG. 6. FIG. 6A is a flowchart illustrating a flow of the setting processing S21C.

As illustrated in FIG. 6A, the setting processing 21C includes creation step S21C1 and setting step S21C2.

Creation step S21C1 is a step that creates a regression tree having each of the attributes included in the attribute group GA as the explanatory variable and the reviewing time as the objective variable by referring to the sample data described above. FIG. 6B shows an example of the regression tree created by creation step S21C1. Creation step S21C1 is executed by the controller 12 of the computer 1. As the method for creating the regression tree, it is possible to use XGBoost, for example.

Setting step S21C is a step that sets the importance of each of the attributes included in the attribute group GA to the values according to the extent of change in output of the regression tree caused by changing a branch condition corresponding to the respective attribute in the regression tree created by creation step S21C1. Setting step S21C2 is executed by the controller 12 of the computer 1 after executing creation step S21C1.

Note that the importance of each of the attributes set in setting step S21C2 may be the extent of the change in the output itself corresponding to the respective attribute or may be another numerical value calculated from the extent of the change in the output corresponding to the respective attribute, for example. Note, however, that the importance of each of the attributes set in setting step S21C2 is preferable to become higher as the extent of the change in the output corresponding to the respective attribute becomes larger and to become lower as the extent of the change in the output corresponding to the respective attribute becomes smaller.

According to the present specific example, the regression tree acquired by excluding the branch condition corresponding to the attribute selected in the selection processing S22 from the regression tree created in creation step S21C1 can be utilized as the prediction model that is used in the prediction processing S13. Thereby, when performing the construction method S2, the learning processing S23 can be omitted. Therefore, it is possible to suppress the calculation cost required for performing the construction method S2.

### [Kinds of Data]

While the electronic data is mainly described as “text data” in the embodiment, “electronic data” may also include all arbitrary kinds of electronic data expressed in a format that can be processed by the computer 1. The electronic data may be unstructured data with an imperfect structure definition at least in a part thereof, for example, and may broadly include text data including at least a part of a text written in a natural language (for example, an e-mail (including an attached file and header information), a technical document (broadly including a document regarding technical matters such as academic paper, a patent publication, product specifications, a design, or the like), a presentation material, a spreadsheet material, a statement of accounts, a meeting material, a report, a business sales material, a contract, an organization chart, a business operation plan, corporate analysis information, an electronic medical chart, a Web page, a Web log, a comment and the like submitted on a social network service), audio data (for example, data recording conversations, music, or the like), image data (for example, data configured with a plurality of pixels or vector information), video data (for example, data configured with a plurality of frame images), and the like.

Note that each aspect of the present disclosure can be preferably applied to review work for selecting the data to be submitted to the United States Court in a discovery procedure, for example. In such case, the review work is work the reviewer performs to: (1) check each piece of electronic data held by a litigant (custodian); (2) evaluate the relevancy between each piece of the electronic data and the suit; and (3) determine whether or not to employ the data as an evidence submitted to the court, for example. However, the review work to which each aspect of the present disclosure can be applied is not limited to selection and collection work of evidences for the discovery procedure. That is, each aspect of the present disclosure can be applied to general work performed by the reviewer to determine whether or not the electronic data satisfies the predefined extraction condition and, in particular, exhibits the effect thereof for arbitrary review work with which the number of review steps is difficult to be specified before performing the review work. As an example, each aspect of the preset invention can be applied to review work in which a medical doctor or the like (reviewer) checks image data (electronic data) including X-ray images (content) and determines existence of illness. In such case, any feature amounts used in well-known image diagnosis method can be used as the feature amounts described above.

### [Supplementary Note]

The present disclosure is not limited to each of the embodiments described above. Various changes are possible within the scope of the appended claims, and any embodiments acquired by combining the technical means disclosed in each of the different embodiments as appropriate are also included in the technical scope of the present disclosure. Further, it is also possible to form a new technical feature by combining the technical means disclosed in each of the embodiments.

This application claims the benefit of foreign priority to Japanese Patent Applications No. JP2018-203078, filed Oct. 29, 2018, which is incorporated by reference in its entirety.

What is claimed is:

1. An estimation method for estimating a cost required for review work of a data set by using a computer comprising a controller and a memory storing the data set including at least one piece of electronic data, the estimation method comprising:
prediction processing executed by the controller to predict time required for the review work of each piece of electronic data based on a feature amount of a content included in the electronic data;
evaluation processing executed by the controller to evaluate the number of steps required for the review work of the data set based on the time predicted in the prediction processing for each piece of the electronic data; and
estimation processing executed by the controller to estimate the cost required for the review work of the data set based on the number of steps evaluated in the evaluation processing.

2. The estimation method according to claim 1, wherein the prediction processing is processing for predicting the time required for the review work of each piece of the electronic data by using a prediction model constructed by machine learning, the prediction model having the feature amount of the content of each piece of the electronic data as input and having the time required for the review work of the electronic data as output.

3. The estimation method according to claim 1, wherein the evaluation processing is processing for evaluating the number of steps required for the review work of the data set so as to be proportional to a sum total of the time predicted in the prediction processing regarding each piece of the electronic data.

4. The estimation method according to claim 1, wherein the estimation processing is processing for estimating the cost required for the review work of the data set so as to be proportional to the number of steps evaluated in the evaluation processing.

5. The estimation method according to claim 1, wherein the data set includes electronic data for which time required for the review work fluctuates according to the feature amount of the content.

6. The estimation method according to claim 1, wherein the prediction processing is processing for predicting the time required for the review work of each piece of the electronic data based on a feature amount group including a feature amount indicating complexity of the content included in the electronic data.

7. The estimation method according to claim 1, wherein the prediction processing is processing for predicting the time required for the review work of each piece of the electronic data based on a feature amount group including a feature amount indicating size of the content included in the electronic data.

8. The estimation method according to claim 1, wherein the prediction processing is processing for predicting the time required for the review work of each piece of the electronic data based on a feature amount group including a feature amount indicating emotionality of the content included in the electronic data.

9. The estimation method according to claim 1, further comprising, as processing executed prior to the prediction processing:
setting processing executed by the controller to set importance of each of attributes included in a predefined attribute group by taking a plurality of pieces of electronic data for which time required for the review work is actually measured in advance as samples; and
selection processing executed by the controller to select the attribute of the content to be used as the feature amount from the attribute group, and more preferentially select the attribute with higher importance set in the setting processing.

10. The estimation method according to claim 9, wherein the setting processing includes: (1) a calculation step of calculating correlation coefficients between each of the attributes included in the attribute group and actually measured reviewing time by taking a plurality of pieces of electronic data for which time required for the review work is actually measured in advance as the samples; and (2) a setting step of setting the importance of each of the attributes included in the attribute group according to the correlation coefficients corresponding to the attributes calculated in the calculation step.

11. The estimation method according to claim 9, wherein the setting processing includes: (1) a creation step of creating a multiple regression equation having each of the attributes included in the attribute group as an explanatory variable and having actually measured reviewing time as an objective variable by taking a plurality of pieces of electronic data for which time required for the review work is actually measured in advance as the samples; and (2) a setting step of setting the importance of each of the attributes included in the attribute group according to a partial regression variable corresponding to the attribute calculated in the multiple regression equation created in the creation step.

12. The estimation method according to claim 9, wherein the setting processing includes: (1) a creation step of creating a regression tree having each of the attributes included in the attribute group as an explanatory variable and having actually measured reviewing time as an objective variable by taking a plurality of pieces of electronic data for which time required for the review work is actually measured in advance as the samples; and (2) a setting step of setting the importance of each of the attributes included in the attribute group according to an extent of change in the output of the regression tree caused by changing a condition corresponding to the attribute in the regression tree created in the creation step.

13. The estimation method according to claim 1, further comprising, as processing executed prior to the prediction processing, switching processing for switching the feature amount the controller refers to in the prediction processing for each piece of the electronic data according to a kind of the electronic data.

14. A charging method, comprising:
the estimation processing for estimating the cost required for the review work of the data set according to the estimation method of claim 1; and
charging processing for charging a price based upon the review cost estimated in the estimation processing to a client ordering the review work.

15. A computer comprising a controller and a memory storing a data set including at least one piece of electronic data, the computer estimating a cost required for review work of the data set, wherein the controller executes:
prediction processing for predicting time required for the review work of each piece of electronic data based on a feature amount of a content included in the electronic data;
evaluation processing for evaluating the number of steps required for the review work of the data set based on the time predicted in the prediction processing for each piece of the electronic data; and
estimation processing for estimating the cost required for the review work of the data set based on the number of steps evaluated in the evaluation processing.
